(19) United States
(12) Patent Application Publication
(10) Pub. No.: US 2014/0099414 A1
(43) Pub. Date: Apr. 10, 2014

(54) READY-TO-EAT COLD EGG TARTS WITH INGREDIENTS

(71) Applicant: Alice Chang, South Pasadena, CA (US)

(72) Inventor: Alice Chang, South Pasadena, CA (US)

(21) Appl. No.: 13/929,075

(22) Filed: Jun. 27, 2013

Related U.S. Application Data
(60) Provisional application No. 61/710,849, filed on Oct. 8, 2012.

(51) Int. Cl. A23L 1/32

(52) U.S. Cl. CPC A23L 1/3212
USPC 426/298; 426/614

(57) ABSTRACT

Ready to eat cold egg tarts, with a variety of ingredient combinations suitable for healthy consumption. Serving size can be a single serving, or a six pack of servings for convenience such that the inherent nutritional aspects of eggs are able to be included in consumer's diets.

### CROSS-REFERENCE TO RELATED APPLICATION

The present application is related to and claims priority from prior provisional application Ser. No 61/710,849 filed Oct. 10, 2012 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of comestibles and more specifically relates to ready to eat cold egg tarts.

2. Description of the Related Art

Many individuals eat eggs. Eggs are laid by females of many different species, including birds, reptiles, amphibians, and fish, and have been eaten by mankind for thousands of years. Bird and reptile eggs consist of a protective eggshell, albumen (egg white), and vitellus (egg yolk), contained within various thin membranes. Popular choices for egg consumption are chicken, duck, quail, roe, and caviar, but the egg most often consumed by humans is the chicken egg. Egg yolks and whole eggs store significant amounts of protein and choline, and are widely used in cookery. Due to their protein content, they may be categorized as ‘Meats’ within the Food Guide Pyramid. Despite the nutritional value of eggs, they may be time-consuming to prepare and eat. Eggs if not properly prepared may not be safe to eat.

It is desirable to offer nutritious comestibles for consumption. Nutrition, if maintained, may help individuals avoid serious health problems. Eggs are a healthy food choice, as mentioned; however eggs may not typically be offered in a conveniently readily edible form. For example many individuals eat eggs for breakfast; however eggs are typically not conducive to portability when eaten and is thus not normally eaten throughout the day. It is desirable that consumers have a means to eat cooked eggs as a healthy comestible. However, when people's schedules are busy convenience may outweigh nutrition which is not desirable in the long-term. It is desirable to have foods such as eggs that are nutritious and also convenient to eat. A more efficient option is needed wherein eggs can be produced in such a form.

Various attempts have been made to solve the above-mentioned problems such as those found in U.S. Pat. and Pub. Nos. 6,391,371; 6,235,325; 3,547,658; 5,151,293; 2006/0073239; and 3,958,035. This art is representative of comestibles relating to eggs. None of the above inventions and patents, taken either singly or in combination, is seen to describe the invention as claimed.

Ideally, ready to eat cold egg tarts should provide nutrition and convenience to consumers and, yet would be manufactured at a modest expense. Thus, a need exists for ready to eat cold egg tarts to avoid the above-mentioned problems.

### BRIEF SUMMARY OF THE INVENTION

In view of the foregoing disadvantages inherent in the known egg-related comestibles art, the present invention provides novel ready to eat cold egg tarts. The general purpose of the present invention, which will be described subsequently in greater detail is to provide ready to eat cold egg tarts with a variety of ingredients. It is desirable to have cold egg tarts that individuals of any age can enjoy and benefit from nutritionally.

The present invention eliminates the hassle associated with having to prepare and cook eggs before eating them. It also saves people time and energy when preparing and cooking eggs, especially at breakfast when time is limited as people are getting ready to go to school or work. The present invention allows people to eat affordable, nutritious, and delicious egg preparations at their convenience. These can be eaten for breakfast, lunch, dinner, and snacks. Further, they may help with weight management, muscle strength, healthy pregnancies, brain function, eye health, and more.

A ready to eat cold egg tart product is disclosed herein comprising ingredients combined in proportions substantially including: at least one portion of an egg (or whole eggs less the shell); milk; additives; and flavorings. The milk; at least one portion of an egg; additives and flavorings are stirred, mixed as an admixture, cooked by boiling, and cooled in the refrigerator to form cold egg tarts as a ready to eat egg tart product. The flavorings cause the cold egg tarts to be appropriately flavored for consumption when cooked in a cooking process. The cold egg tarts are high in nutrition and are suitable for readily consuming.

Examples: An example of the present invention is an egg tart made with eggs, and milk. Another example may comprise sweet egg tart with fruit juice being used is made with eggs, coconut milk, and pineapple juice. Yet another example of sweet egg tart is made with eggs, milk, and chocolate. An example of a salty egg tart may be made with eggs, soy milk, shrimp, garlic, and salt. Another example of the salty and spicy egg tart is made with eggs, milk, cuttle fish, salt, garlic, and chili. And another example is made with eggs, fish eggs, milk, and honey. Many other combinations are possible.

One method of preparing ready to eat cold egg tarts may comprise the steps of: stiffing and mixing an egg-portion(portion of egg), milk, additives and flavorings; cooking the mixed ingredients by boiling; cooling the egg tarts in a refrigerator to congeal and solidify; and packaging to preserve freshness once solidified.

The present invention holds significant improvements and serves as a ready to eat cold egg tarts system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, ready to eat cold egg tarts, constructed and operative according to the teachings of the present invention.

FIG. 1 shows a perspective view illustrating ready to eat cold egg tarts according to an embodiment of the present invention.

FIG. 2 is a perspective view illustrating the ready to eat cold egg tarts (as prepared for consumption) according to an embodiment of the present invention of FIG. 1.

FIG. 3 is a flowchart illustrating a method of preparing the ready to eat cold egg tarts according to an embodiment of the present invention of FIGS. 1-2.

The various embodiments of the present invention will hereinafter be described in conjunction with the appended drawings, wherein like designations denote like elements.

### DETAILED DESCRIPTION

As discussed above, embodiments of the present invention relate to a comestible and more particularly to ready to eat cold egg tarts as used to improve the health of consumers.

Generally speaking, ready-to-eat cold egg tarts, as disclosed herein, provide people with a healthy and good-tasting egg meal or snack that may be consumed at any time of the day. This innovative product may comprise a mixture of eggs (yolks and egg whites or just egg whites), mixed with a variety of different ingredients, seasonings, and toppings. The mixture may be boiled, baked or steamed until proper internal temperatures are reached.

The different toppings and ingredients may include milk, cream, cheese, cream cheese, caramel, butterscotch, peanut butter, seafood, meat, vegetable, chocolate, coffee, tea, fruit juice, fruit, nut, bean, cereal, vegetable oil, spices, seasonings, and variety of other items as per consumer preference. And the different topping and ingredients may be cut into small pieces or ground into tiny particles. The egg tarts can be made into different flavorings, such as sweet, fruity, spicy or salty.

The egg tarts may be packaged in airtight containers, made from paper, plastic, glass, metal, or other suitable materials, to preserve freshness. They may be offered in single or multiple-tart packs. Each tart may be packaged in an individual, cube-shaped container, measuring approximately 2″ to 3″ in length on each side. They may be stored in the refrigerator and may have optional heating instructions for the egg tarts to be reheated in the conventional and microwave oven.

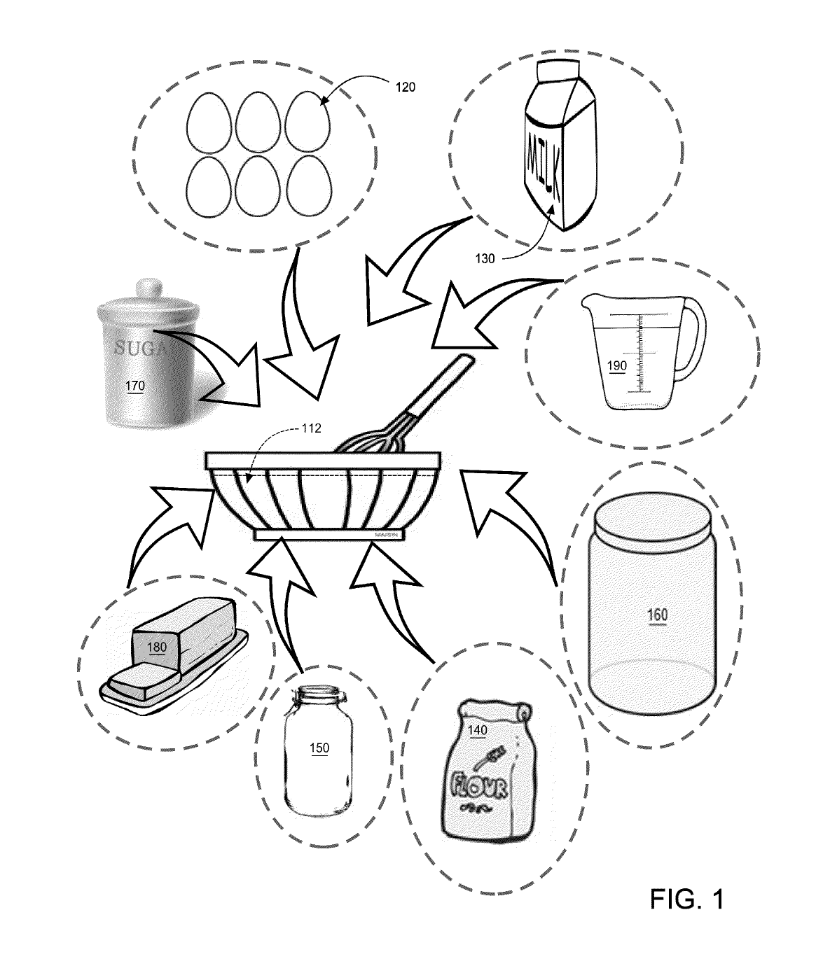

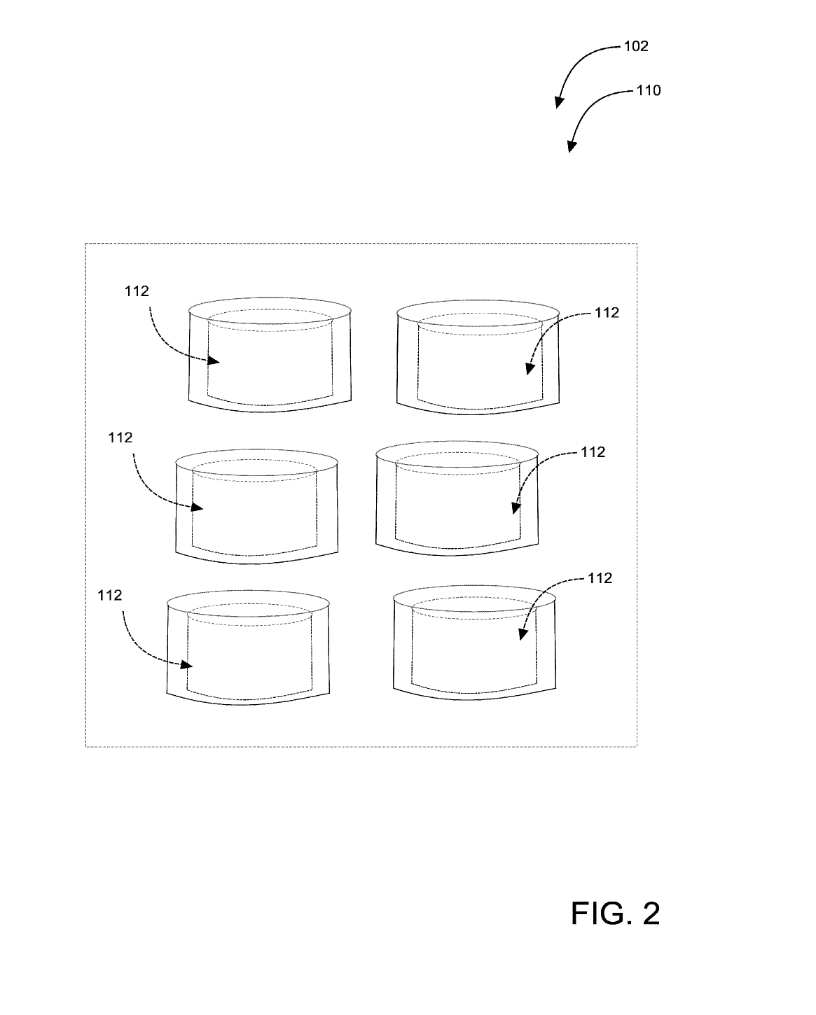

Referring to the drawings by numerals of reference there is shown in FIGS. 1-2, perspective views illustrating ready to eat cold egg tarts 110 according to embodiments of the present invention.

Ready to eat cold egg tart product 102 comprises ingredients combined in proportions substantially including at least one portion of an egg 120; flour 140; sugar 170; butter 180; milk 130; additives 150; and flavorings 160. The least one portion of an egg 120 (yolk or white individually or both yolk and white), flour 140, sugar 170 are mixed to form a dough. Butter 180 is then preferably mixed with dough and formed into shells.

Milk 130; at least one portion of an egg 120 (yolk or white or both); additives 150; and flavorings 160 are stirred, mixed as an admixture and cooked in dough (tart shells) to form cold egg tarts 110 as ready to eat egg tart product 102. Flavorings 160 cause cold egg tarts 112 to be appropriately flavored for consumption when cooked in a cooking process; wherein cold egg tarts 112 are high in nutrition and suitable for readily consuming once cooled.

The portion of an egg 120 may comprises an egg white and/or the portion of an egg 120 may comprise yolk so as to comprise vitamins A, D, and E. Egg whites may be used without egg yolks to remove fat content. Milk 130 may be selected from the group consisting of whole milk, lowfat milk, nonfat milk, soy milk, coconut milk, almond milk, vanilla milk, and cream. Cold egg tart product 102 may further comprise at least one cheese. Cheeses of many different kinds may be used as per personal preference. Cream cheese may be used when desired.

Additives 150 of ready to eat cold egg tart product 102 may comprise spices; wherein spices are selected from the group consisting of salt, pepper, garlic, ginger, onion, chili, curry, vinegar, lemon, lime, basil, thyme, rosemary, parsley, peppermint, and soup stock. Alternately, ready to eat cold egg tart product 102 may comprise a sweetener; wherein sweetener is preferably selected from the group consisting of sugar 170, syrup, and honey, although other sweeteners may be used. In certain embodiments ready to eat cold egg tart product 102 may further comprise at least one vegetable; wherein vegetables are selected from the group consisting of onion, carrot, pea, corn, beet, redish, turnip, pepper, tomato, asparagus, cucumber, zucchini, eggplant, squash, and mushrooms. In other embodiments ready to eat cold egg tart product 102 may further comprise shrimp and/or other seafood and/or meat. The seafood may comprise squid, cuttle fish, shrimp, crab, crayfish, octopus, clam, oyster, scallop, lobster, abalone, conch, jellyfish, shrimp roe, fish roe, and fish. The meat may comprise bacon, sausage, beef, lamb, pork, chicken, and duck. Other meats may be used as per consumer preference. The cooking process of ready to eat cold egg tart product 102 may comprise boiling, baking or steaming.

Egg tarts can also be created with the making of the tart shells.

A sample recipe may comprise: Step I. In a bowl, mix together (confectioners' or other) sugar and flour. Mix in butter with a fork until it is in small crumbs. Stir in the egg 120 and vanilla (or other flavorings 160) until the mixture forms dough. Add more butter if dough is too dry, or more flour, if the dough feels ‘greasy’. Shape dough into 1½ inch balls, and press the balls into tart molds.

Step II. Preheat the oven to 230 degrees C. (450 degrees F.). Combine sugar and water in a sauce pan, and boil dissolving the sugar then cool to room temperature. Strain the eggs 120 using a sieve, and mix into the sugar mixture. Stir in milk 130 and desired flavorings 160 (such as vanilla) and/or additives 150 (such as meat or seafood or the like as described above). Strain the filling through a sieve to make the solution consistent, and fill the tart shells. Step III. Bake for 15 to 20 minutes until golden brown and serve once cooled.

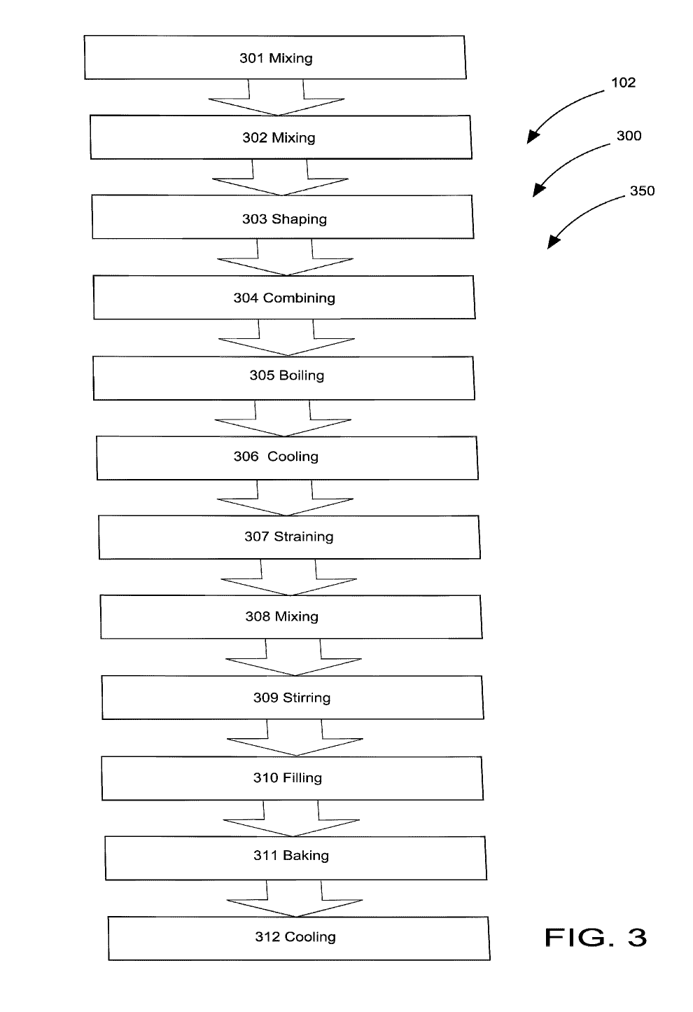

Referring now to FIG. 3, a flowchart 350 illustrating a method of preparing 300 ready to eat cold egg tarts 110 according to an embodiment of the present invention of FIGS. 1-2.

A method of preparing 300 ready to eat cold egg tarts 110 comprises the steps of: step one 301 mixing a first-sugar-portion (some of sugar 170), flour 140 and a first-egg-portion (portion of egg 120) to form a dough; step two 302 mixing in butter into dough; step three 303 shaping dough to form tart shells; step four 304 combining a second-sugar-portion (some of sugar 170) with water 190 to form a sugar-water solution; step five 305 boiling sugar-water solution; step six 306 cooling sugar-water solution; step seven 307 straining a second-egg-portion (portion of egg 120) using a sieve; step eight 308 mixing strained second-egg-portion (portion of egg 120) into cooled sugar-water solution; step nine 309 stiffing in milk 130, additives 150 and flavorings 160; step ten 310 filling tart shells to make filled-tart-shells; step eleven 311 baking filled-tart-shells; and step twelve 312 cooling filled-tart-shells to produce ready to eat cold egg tarts 110 for healthy consumption.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A ready to eat cold egg tart product comprising ingredients combined in proportions substantially including:
at least one portion of an egg;
milk;
additives; and
flavorings;
wherein said milk, said at least one portion of an egg; said additives and said flavorings are stirred, mixed as an admixture; cooked and cooled to form cold egg tarts as a ready to eat egg tart product;
wherein said flavorings cause said cold egg tarts to be appropriately flavored for consumption when cooked in a cooking process; and
wherein said cold egg tarts are high in nutrition and suitable for readily consuming.

2. The ready to eat cold egg tart product of claim 1 wherein said portion of an egg comprises an egg white.

3. The ready to eat cold egg tart product of claim 2 wherein said portion of an egg comprises said egg white and said yolk so as to comprise vitamins A, D, and E.

4. The ready to eat cold egg tart product of claim 1 wherein said milk is selected from the group consisting of whole milk, lowfat milk, nonfat milk, soy milk, coconut milk, almond milk, vanilla milk, and cream.

5. The ready to eat cold egg tart product of claim 1 further comprising at least one cheese.

6. The ready to eat cold egg tart product of claim 1 further comprising cream cheese.

7. The ready to eat cold egg tart product of claim 1 wherein said additives comprise spices.

8. The ready to eat cold egg tart product of claim 7 wherein said spices are selected from the group consisting of salt, pepper, garlic, ginger, onion, chili, curry, vinegar, lemon, lime, basil, thyme, rosemary, parsley, peppermint, and soup stock.

9. The ready to eat cold egg tart product of claim 1 further comprising a sweetener.

10. The ready to eat cold egg tart product of claim 9 wherein said sweetener is selected from the group consisting of sugar, syrup, and honey.

11. The ready to eat cold egg tart product of claim 1 further comprising at least one vegetable.

12. The ready to eat cold egg tart product of claim 11 wherein said vegetables are selected from the group consisting of onion, carrot, pea, corn, beet, redish, turnip, pepper, tomato, asparagus, cucumber, zucchini, eggplant, squash, and mushrooms.

13. The ready to eat cold egg tart product of claim 1 further comprising seafood.

14. The ready to eat cold egg tart product of claim 1 further comprising meat.

15. The ready to eat cold egg tart product of claim 13 wherein said seafood comprises shrimp, squid, cuttle fish, shrimp, crab, crayfish, octopus, clam, oyster, scallop, lobster, abalone, conch, jellyfish, shrimp roe, fish roe, and fish.

16. The ready to eat cold egg tart product of claim 14 wherein said meat comprises sausage, beef, lamb, pork, chicken, and duck.

17. The ready to eat cold egg tart product of claim 1 wherein said cooking process comprises baking.

18. The ready to eat cold egg tart product of claim 1 wherein said cooking process comprises steaming.

19. The ready to eat cold egg tart product of claim 1 wherein said cooking process comprises boiling.

20. A method of preparing ready to eat cold egg tarts comprising the steps of:
stirring and mixing in eggs, milk, additives and flavorings;
cooking mixed ingredients by boiling;
cooling egg tarts in a refrigerator to congeal and solidify; and
packaging to preserve freshness once solidified.
